(19) United States
(12) Patent Application Publication
(10) Pub. No.: US 2001/0045680 A1
(43) Pub. Date: Nov. 29, 2001

(54) Process for producing special color effects in shaped articles

(76) Inventors: William G. Blasius, Charlton, MA (US); Roy D. Caless, Leominster, MA (US); David G. Gaboury, Holden, MA (US); Daniel Y. Choi, Worcester, MA (US)

Correspondence Address: CLARIANT CORPORATION, 4331 CHESAPEAKE DR, ATTN: INDUSTRIAL PROPERTY DEPT, CHARLOTTE, NC, 28216, US

(21) Appl. No.: 09/771,803

(22) Filed: Jan. 29, 2001

Related U.S. Application Data
(60) Provisional application No. 60/179,339, filed on Jan. 29, 2000.

(51) Int. Cl. B29C 47/04

(52) U.S. Cl. 264/75

(57) ABSTRACT

A process for producing an article having a surface color swirl effect comprising:

a) providing at least one color concentrate comprising a colorant carried in a mixture of a crystalline organic polymer and an amorphous organic polymer;

b) providing a flowable organic polymer compatible with the color concentrate of step a);

c) transferring the color concentrate of step a) and the flowable organic polymer of step b) to an extruder or molding machine;

d) providing sufficient heat to maintain the temperature of the mixture of step c) above the glass transition temperatures of the polymers of steps a) and b) and above the temperatures at which the amorphous polymers of step a) melt or flow, but below the melting or flow temperature of the crystalline polymer of step a);

e) forming an article with sufficient pressure and mixing necessary to impart a color swirl effect on the article surface.

### CROSS-REFERENCE TO RELATED APPLICATION

This application claims the benefit of U.S. Provisional Application No. 60/179,339, filed Jan. 29, 2000.

### BACKGROUND OF THE INVENTION

The present invention relates to a process wherein color concentrates are used in the extrusion or molding of shaped articles suitable for use as barrels for writing instruments, such as pens or pencils, which shaped articles have a special color swirl or “tortoise shell” effect at least on the surface. The barrel of such a writing instrument is normally a relatively thin-walled essentially cylindrical or tubular part that may be produced by molding or extruding a thermoplastic or plasticized non-thermoplastic material. Such moldable or extrudable materials may include polyethylene, polypropylene, plasticized cellulose acetate (CA), polystyrene, a polyester such as poly-(ethylene terephthalate) (PET) or poly-(butylene terephthalate), ethylene-vinyl acetate copolymers, acrylic and methacrylic polymers and copolymers such as a polystyrene/C₁-C₄ alkyl acrylate or methacrylate copolymer, polymethylpentene, polybutene-1, polyvinyl chloride, an acrylonitrile-butadiene-styrene polymer, an acrylonitrile-EPDM-styrene polymer, a polyamide such as Nylon-6, a polycarbonate, or a polyacetal polymer or copolymer.

Shaped articles suitable for use as barrels for writing instruments may be produced by extrusion or molding, such as injection or blow molding. Extrusion processes utilizing one or more screws may sometimes be preferred when producing shaped articles having a substantially constant diameter, because the extrudate may be produced as a continuous or semi-continuous shaped article. This can enable one to manufacture more uniform parts at a significantly higher production rate when compared with a molding process, particularly those molding processes that require a subsequent cutting and/or milling step. In the past barrels for writing instruments have been produced by processes such as those set forth below.

1. A colored CA block having multiple colors dispersed throughout the block is produced by mixing ground-up chips of multiple colored CA, which are put into a press and mixed with a suitable plasticizer. The mixed materials are fused into a solid block by the application of sufficient heat and pressure. The colored block is then cut and milled into individual multi-colored parts suitable for use as barrels for writing instruments.

2. Plasticized CA is coextruded with one or more color concentrates using either a single or multiple screw extruder. A multi-spiral extrusion die is utilized to physically insert the colored resin concentrate throughout the cross section of the extrudate by having the spirals on the die staggered in multiple planes. The extrudate is then cut and milled into individual tubular parts suitable for pen barrels.

3. Polyethylene or polypropylene is mixed with a higher melting crystalline polyolefin such as polymethylpentene (PMP), which is used as a carrier for the color concentrates. At the normal temperature for injection molding polyethylene or polypropylene, the PMP carrying the colorants remains as a solid and is dispersed through the melt to provide a three-dimensional swirl effect. Plunger-type injection molding machines are usually used because of the need to minimize intimate mixing, which would provide a uniformly colored extrudate rather than one having a color swirl effect.

4. In a similar plunger-type injection molding process, polystyrene is extruded using crystallized PET as the carrier for the color concentrate, but interfacial adhesion between the color swirl and the polystyrene is frequently not sufficient.

5. A polymer may also be molded into tubular parts suitable for writing instrument barrels and then colored using a pre-printed tortoise shell colored pattern.

### SUMMARY OF THE INVENTION

The present invention relates to a process for producing a shaped article suitable for use as a barrel for a writing instrument. In particular, the subject process relates to a process for producing a shaped article having a color swirl or “tortoise shell” effect at least on the surface of such a shaped article. The subject process utilizes color concentrates that comprise a colorant that is preferably an organic, inorganic or pearlescent pigment. The color concentrate that provides the color swirl effect comprises one or more colorants contained in a carrier that comprises a mixture of a highly crystalline polymer, such as a crystalline or syndiotactic polystyrene, and a compatible essentially non-crystalline or amorphous polymer, such as amorphous polystyrene or styrene copolymer.

The color concentrate in the carrier is then mixed with a base flowable, preferably thermoplastic, resin that is suitable for use in producing a shaped article suitable for use as a barrel for a writing instrument. Such preferred base thermoplastic resins may include, for example, polystyrene, a styrene-acrylic copolymer, a styrene-acrylonitrile copolymer or a polycarbonate. When a background color is desired, another colorant is also provided in an amorphous polymer carrier.

Preferably, the color swirl effect is not just on the surface, but is present throughout the cross section of the shaped article produced by the process of the present invention. Normally, from about 1 percent to about 10 percent, preferably from about 1 percent to about 5 percent (by weight of the total extrudable or moldable composition) of color concentrate is used in the present process. Utilizing color concentrates as set forth in the process of the present invention provides shaped articles wherein such color concentrates are very compatible with the moldable or extrudable materials utilized as the base resin for producing such parts. Such compatibility enables one to easily manufacture thin walled parts having sufficient integrity, interfacial adhesion and strength to be used as barrels for writing instruments.

The process of the present invention comprises:

1) providing a first color concentrate comprising a mixture of: a) a first colorant carried in a mixture of a crystalline organic polymer and an amorphous (non-crystalline or very low crystalinity) organic polymer, and optionally, b) a second color concentrate comprising a second colorant carried in an amorphous organic polymer, which amorphous polymer is compatible with the polymers used as carriers for the first colorant of step a);

2) providing a flowable polymer, preferably a thermoplastic amorphous organic polymer that is compatible with the color concentrate of step 1a), and the optional the color concentrate of step 1b), which flowable polymer is capable of being formed into a shaped article upon the application of sufficient heat and pressure;

3) transferring the color concentrate from step 1a), and optionally the color concentrate from step 1b), and the flowable organic polymer from step 2), to an extruder or molding machine capable of producing shaped articles;

4) providing sufficient heat to maintain the temperature of the mixture in step 3) above the glass transition temperatures of both the crystalline and amorphous polymers of steps 1) and 2), and also above the temperature at which both the amorphous polymer of step 1) and the thermoplastic polymer of step 2) melts or flows (the melting or flow temperature), but also below the melting or flow temperature of the crystalline polymer of step 1 a);

5) forming a shaped article by providing sufficient pressure and mixing in the extruder or molding machine necessary to produce a shaped article and thereby distributing the color concentrate from 1a) on at least the surface of the shaped article so as to impart a color swirl effect on at least the surface of the shaped article, and optionally having the color concentrate from step 1b) distributed throughout at least the surface of the shaped article to provide a substantially uniform background color.

The present process provides significant advantages over the prior art processes used to produce shaped articles having special surface color effects, some of which processes were set forth above. Among these advantages are: 1) the ability to use a standard screw configuration when forming a shaped article, 2) the elimination of the need for a plunger-type molding machine, 3) the ability to use typical machine settings in producing the desired shaped article, 4) the elimination of the need for low back pressure in producing such a shaped article, and 5) the elimination of the need for special extrusion dies.

Having a colorant dispersed in a crystalline polymer alone provides a dispersion in the shaped article of unmelted pellets or color pearls, under normal extrusion or molding conditions. Using only an amorphous polymer as the carrier for the colorant provides a fine dispersion of the colorant that is useful only for producing a substantially uniformly colored shaped article, rather than one having color swirls at least on its surface. Utilizing the combination of an amorphous polymer and a crystalline polymer as the carrier for the colorant(s) in the present process enables one to produce shaped articles having color swirls and streaks at least on the surface, and which is also capable of providing such a color effect that is three-dimensional.

### DESCRIPTION OF THE PREFERRED EMBODIMENTS

The concentration of colorant, preferably comprising one or more pigments, in both the color concentrate and the final polymer mixture to be formed into a shaped article depends on the extent and color intensity of the desired color effects. However, the concentration of colorant in the color concentrate utilizing an amorphous polymer and a crystalline as a carrier, which color concentrate provides the background color, is preferably from about 0.5 weight percent, preferably about 1 weight percent, up to about 5 weight percent, based on the total weight of this color concentrate. The concentration of colorant in the carrier comprising a mixture of a crystalline and an amorphous polymer, is preferably from about 0.5 weight percent to 5 weight percent, based on the total weight of this color concentrate. The color concentrates are preferably distributed throughout the cross section of the shaped article so as to enable the production of a shaped article having a three-dimensional color effect on its surface.

Among the preferred polymers that may be used as either a carrier for the colorant(s) or as the base resin for the shaped article are: 1) crystalline or amorphous polymers of vinyl aromatic monomers that are unsubstituted or substituted by a C₁ to C₄ alkyl group or a chlorine atom, 2) amorphous copolymers of such a vinyl aromatic monomer, and acrylonitrile or methacrylonitrile that is unsubstituted or substituted by a C₁ to C₄ alkyl group, 3) amorphous copolymers of such a vinyl aromatic monomer and a C₁ to C₄ alkyl acrylate or methacrylate, and 4) amorphous copolymers of such a vinyl aromatic monomer and a C₄ to C₆ conjugated diolefin. In the present process it is necessary to maximize the compatibility between the crystalline and amorphous polymers used as carriers for the colorant, and between the carrier polymers and the polymer used as the base resin for the shaped article. Therefore, it is frequently preferred to use polymers that are similar chemically to perform all of these functions. For example, if amorphous polystyrene is the base resin for the shaped article, a crystalline and an amorphous styrene polymer may be used as the carrier resins for the colorants.

Among the specific preferred polymers are crystalline and amorphous polystyrene, an amorphous copolymer of styrene and acrylonitrile or methacrylonitrile, an amorphous copolymer of styrene and a C₁ to C₄ alkyl acrylate or methacrylate such as methyl methacrylate, and an amorphous copolymer of styrene and butadiene or pentadiene. The ratio of crystalline and amorphous polymer(s) used in the subject process as the carrier for the colorants may vary over a wide range. For mixtures of the preferred types of amorphous and crystalline polymers set forth above, the preferred range is from 50 to 99 weight percent amorphous polymer or copolymer to 1 to 50 weight percent of the crystalline polymer or copolymer. In choosing the material that will serve as the base resin for the shaped article, one will preferably choose a material that exhibits good scratch resistance and has good surface hardness.

The optional, but preferred, background color may be opaque, translucent or transparent. An opaque background provides color swirls at random spots on the surface of the shaped article and provides a two-dimensional effect. A translucent background enables one to produce streaks or swirls of color having some depth and to provide the beginnings of a three-dimensional effect. Providing an essentially transparent colored background produces fully developed three-dimensional color swirls, which is a full “tortoise shell” effect.

The pigment is preferably dispersed in the carrier using a single or multiple screw extruder, although other mechanical mixing devices well known in the art may also be used. Normally, the color concentrate in the carrier containing the crystalline polymer is formulated in an extruder, usually at a temperature of from about 250° C. to about 300° C., depending upon the melting point of the carrier resin(s). The color concentrate in the carrier containing a mixture of an amorphous polymer and a crystalline polymer is also normally formulated in an extruder, usually at a temperature of from about 200° C. to 250° C., depending upon the melting point of the carrier resins. The formation of the shaped article takes place after the polymer/color concentrate mixture in the molding or extrusion apparatus has been raised to a temperature at least equal to the melting or flow temperature of both the amorphous polymer of step 1) and the flowable, preferably thermoplastic, polymer of step 2), but below the melting or flow temperature of the crystalline polymer of step 1a). At this point the molten or flowing mixture may be extruded or the molding process is terminated, to provide a shaped article having the desired color characteristics. Preferably, the shaped article is injection molded at a temperature of from about 200° C. to a temperature less than 275° C.

### EXAMPLES

### Example 1

The following were mixed in a single screw extruder at a temperature of about 270° C. to provide a first color concentrate: 1) 1706.7 grams BX0420 MIPS (Medium impact polystyrene available from BASF, having a glass transition temperature of 95° C. and a flow temperature of 160-200° C.), 2) 378.9 grams QUESTRA QA 101 (Syndiotactic [crystalline] polystyrene available from Dow Chemical, having a glass transition temperature of 95° C. and melting or flow temperature of 275° C.), 3) 17.1 grams MONARCH BLACK 700 (Carbon black available from Cabot), 4) 0.08 grams HLBERCARB Q 6 (Calcium carbonate available from J. M. Huber), 5) 428.6 grams SANDOPLAST RED G POWDER (Red dye available from Clariant Corp.), 6) 15.0 grams POLYSOLVE YELLOW 33G (Yellow dye available from Polysolve) and 7) K-RESIN KR05 (75% Styrene-25% Butadiene copolymer available from Phillips, having a glass transition temperature of about 90° C. and a flow temperature of 160-200° C.). A styrene-acrylic copolymer and blue dye were mixed in a single screw extruder at a temperature of about 225° C. to provide a second color concentrate containing 1543.0 grams NAS 30 ACRYLIC (Styrene-acrylic copolymer available from Nova Chemicals, having a glass transition temperature of 100° C. and a melting or flow temperature of 160-200° C.) and 272.0 grams MACROLEX BLUE 3R (Blue dye available from Bayer). Twenty grams of the first color concentrate and twenty grams of the second color concentrate were fed together with 1.996 kilograms of amorphous polystyrene resin (having a glass transition temperature of 95° C. and a flow temperature of 160-200° C.) into an injection molding machine equipped with a standard runner system. The temperature in the injection molding machine was maintained at about 225° C., which is sufficiently high to cause the styrene-butadiene copolymer and the medium impact polystyrene to flow, but not the SPS. The color concentrates were sufficiently dispersed in the molten mixture and the resulting molded shaped article had a substantially uniform blue background and a multicolored swirl effect throughout the cross section of the resulting shaped article.

### Example 2

The process of Example 1 was repeated except that the first color concentrate contained 476.7 grams QUESTRA QA 101 (SPS), 885.3 grams 390-11 GPPS (General purpose polystyrene available from American Polymers, having a glass transition temperature of 95° C. and a melting or flow temperature of 160-200° C.) and 454.0 grams AFFLAIR 363 SHIMMER GOLD (Pearlescent pigment available from EM Industries). The extrusion and molding temperatures were the same as Example 1 and the injection molding temperature of about 225° C. was above the flow temperature of the 390-11 GPPS, but below the flow temperature of the SPS. The resulting shaped article had a substantially uniform blue background and a color swirl effect throughout the cross section of the resulting shaped article.

### Example 3

The process of Example 1 was repeated except that the first color concentrate contained 476.7 grams QUESTRA QA 101, 885.3 grams 390-11 GPPS and 454.0 grams AFFLAIR 163 SHIMMER PEARL (Pearlescent pigment available from EM Industries). The extrusion and molding temperatures were the same as Example 1 and the injection molding temperature of about 225° C. was above the flow temperature of the 390-11 GPPS, but below the flow temperature of the SPS. The resulting shaped article had a substantially uniform blue background and a color swirl effect throughout the cross section of the resulting shaped article.

### Example 4

The process of Example 1 was repeated except that the first color concentrate contained 454 grams of QUESTRA QA-1 (SPS), 454 grams of KRATON G1651 (available from Shell), 72 grams of titanium dioxide white pigment (available from DuPont as R-101). The second color concentrate had the same resins in the same ratios, however, with 72 grams of carbon black pigment (available as VULCAN 9A-32 from Cabot). The extrusion and molding conditions were similar to Example 1 except the extrusion and molding temperatures were in the range of 180° C. to 260° C. The color concentrates were let down into PRO-FAX (a polypropylene available from Basell), in ratios of 1:1 for a total of four percent. The resulting shaped article had a clear background with discrete black and white forms suspended within the article.

1. A process for producing a shaped article having a color swirl effect on the surface of said shaped article, the process comprising:
a) providing a first color concentrate comprising a first colorant carried in a mixture of a crystalline organic polymer and an amorphous organic polymer, and optionally, providing a second color concentrate comprising a second colorant carried in an amorphous organic polymer, which amorphous polymer is compatible with the polymers used as carriers for the first colorant;
b) providing a flowable organic polymer that is compatible with the color concentrates of step a);
c) transferring the color concentrates of step a) and the flowable organic polymer of step b) to an extruder or molding machine capable of producing shaped articles;
d) providing sufficient heat to maintain the temperature of the mixture of step c) above the glass transition temperatures of the polymers of steps a) and b) and above the temperatures at which the amorphous polymers of step a) melt or flow, but below the melting or flow temperature of the crystalline polymer of step a);
e) forming a shaped article by providing sufficient pressure and mixing necessary to produce a shaped article and thereby distributing the color concentrates so as to impart a color swirl effect on the surface of said shaped article.

2. The process of claim 1, wherein the flowable organic polymer of step b) is a thermoplastic.

3. The process of claim 1, wherein the first and second colorants are pigments.

4. The process of claim 1, wherein the amorphous organic polymer of step a) and the flowable organic polymer of step b) are both selected from the group consisting of: a) polymers of vinyl aromatic monomers that are unsubstituted or substituted by a C₁ to C₄ alkyl group or a chlorine atom, b) copolymers of such a vinyl aromatic monomer, and acrylonitrile or methacrylonitrile that is unsubstituted or substituted by a C₁ to C₄ alkyl group, c) copolymers of such a vinyl aromatic monomer and a C₁ to C₄ alkyl acrylate or methacrylate, and d) copolymers of such a vinyl aromatic monomer and a C₄ to C₆ conjugated diolefin.

6. The process of claim 1, wherein the crystalline organic polymer of step a) is polymer of vinyl aromatic monomers that are unsubstituted or substituted by a C₁ to C₄ alkyl group or a chlorine atom.

7. The process of claim 1, wherein in step c) the extruder or molding machine is an injection molding machine or a blow molding machine.

8. The process of claim 1, wherein in step c) the extruder or molding machine is an extruder.

9. The process of claim 1, wherein the first colorant comprises from 0.5 weight percent to 5 weight percent of the first color concentrate.

10. The process of claim 1, wherein the second colorant comprises from 0.5 weight percent to 5 weight percent of the second color concentrate.

11. The process of claim 1, wherein the shaped article is a barrel for a writing instrument.
